(19) United States
(12) Patent Application Publication
(10) Pub. No.: US 2017/0268801 A1
(43) Pub. Date: Sep. 21, 2017

(54) STAMPED RESISTIVE ELEMENT FOR USE IN ELECTRICAL EQUIPMENT, MANUFACTURING PROCESS OF STAMPED RESISTIVE ELEMENT AND APPARATUS EQUIPPED WITH STAMPED RESISTIVE ELEMENT

(71) Applicant: ACTION TECHNOLOGY INDUSTRIA E COMERCIO DE ELETROELETRONICOS LTDA., Indaiatuba - SP (BR)

(72) Inventor: Roberto Jun Ikesaki, Sao Paulo (BR)

(73) Assignee: ACTION TECHNOLOGY INDUSTRIA E COMERCIO DE ELETROEL ETRONICOS LTDA., Indaiatuba - SP (BR)

(21) Appl. No.: 15/614,952

(22) Filed: Jun. 6, 2017

Related U.S. Application Data
(63) Continuation of application No. PCT/BR2016/000086, filed on Feb. 12, 2016.

(30) Foreign Application Priority Data
Feb. 12, 2016 (BR) BR102016003027-7
Mar. 24, 2016 (BR) BR102016006633-6

(51) Int. Cl. F24H 3/04; H05B 3/10; H05B 3/02; H05B 3/00

(52) U.S. Cl. CPC F24H 3/0423; H05B 3/0014; H05B 3/10; H05B 3/026; H01C 7/00

(57) ABSTRACT

A stamped resistive element for use in electrical equipment, manufacturing process of stamped resistive element and apparatus equipped with stamped resistive element are provided. The stamped resistive element is produced from a stamping process and is intended to be used in replacement of conventional helical electrical resistances, whether in hair dryers and similar equipment or in other types of heating equipment. The stamped resistive element is produced as a blank from a metal sheet presenting a known resistive coefficient.

### CROSS REFERENCE TO RELATED APPLICATIONS

This application is a continuation of International Application No. PCT/BR2016/000086 filed on Feb. 12, 2016, which claims priority of Brazilian application No BR102016003027-7 filed on Feb. 12, 2016 and claims priority of Brazilian application No BR102016006633-6 filed on Mar. 24, 2016, the entire contents of all of which are incorporated by reference herein.

### BACKGROUND

1. Field of the Invention

This invention patent application proposes a new type of stamped resistive element for use in electrical equipment, which can include hair dryers and other similar equipment, as well as other types of equipment that somehow operate by heating a fluid, whether gaseous or liquid. This invention patent application also addresses the manufacturing process whereby the stamped resistive element is produced.

This invention patent application proposes a new type of resistive element for use in electrical equipment, and can be used in place of conventionally used electrical resistances. The stamped resistive element herein described differs from the conventional electrical resistances because it is produced by the stamping process. This invention patent application also deals with the process through which the resistive element described herein is obtained. This invention patent application also deals with an apparatus that uses the new stamped resistive element, which is defined as a hair dryer.

2. Description of Related Art

Hair dryers and other equipment that operate by heating principle are normally provided with electrical resistances that, when heated, promote by thermal exchange effect the heating of the airflow which is forced to circulate through them

In the case of hair dryers and similar equipment, the electrical resistance is normally mounted in a support structure, around which the helical body defining the resistance needs to be suitably arranged and secured.

Conventional electrical resistances present a series of problems that arise largely from their physical presentation, which is an extremely malleable helical body, which to be produced in scale requires the use of complex equipment.

From the point of view of the equipment in which this type of resistance is used, there is also a major problem resulting from the fact that the assembly thereof need to be obligatorily manual, thus increasing the final product.

The conventional electrical resistances can be based on the use of wires as well as of metal strips produced with resistive material, which are rolled thus to assume a helical shape.

### SUMMARY

In view of the state of the art described above, it is one of the objects of this invention patent application to provide a stamped resistive element for use in electrical equipment, which is stamped in a blank.

Other object of this invention patent application refers to the manufacturing process of the stamped resistive element, which process is used to enable the production of the resistive element described herein. Said process is a stamping process generating a blank, which configures the resistive element itself.

Yet another object of this invention patent application is to propose an apparatus provided with stamped resistive element, which is defined as a hair dryer presenting a series of innovative technical aspects.

This invention patent application proposes a stamped resistive element for use in electrical equipment, manufacturing process of stamped resistive element and apparatus provided with stamped resistive element, wherein the stamped resistive element itself shows a blank shaped configuration obtained by stamping process by using a metal with known resistive coefficient.

The blank thus produced has a shape pattern that maximizes the area of contact with the fluid medium to be heated (air in the case of hair dryers and similar equipment).

The stamping process stems from a metal laminate that has been subjected to a stamping tool and generates the stamped resistive element in its final form ready to be mounted.

### BRIEF DESCRIPTION OF DRAWINGS

This invention patent application will be described in detail with reference to the drawings listed below, in which:

FIG. 1 illustrates an isolated view of an exemplary embodiment of the resistive element proposed herein.

FIG. 1A schematically illustrates the heating and heat transfer area defined by resistive element herein described;

FIG. 2 illustrates a cut taken from the FIG. 1 as indicated by the cut line “A”-“A”;

FIG. 3 illustrates a perspective view of an example of practical use of the stamped resistive element at hand, where a certain number of units thereof (four units) is mounted in a support structure that can be used, as component, in a hair dryer model, said support structure receiving, in addition to resistive element units, the connection terminals thereof and also a thermostat, as well as electrical conductive wires needed to power the resistive elements;

FIG. 4 illustrates a side view of the structure depicted in FIG. 3;

FIG. 5 illustrates a side view opposed to the structure depicted in FIGS. 3 and 4;

FIG. 6 illustrates a schematic view, which depicts the manufacturing process of the resistive element now proposed; and

FIG. 7 schematically illustrates a general diagram of a generic model of hair dryers incorporating the stamped resistive elements.

### DETAILED DESCRIPTION OF THE INVENTION

this invention patent application proposes a stamped resistive element for use in electrical equipment and manufacturing process of stamped resistive element, wherein the stamped resistive element itself is indicated by the numerical reference 1 and consists of a laminar body 2, which is defined as a strip 3 of the flat surface defining parallel portions 4, each of which having continuity with the next through curved portions 5. The two ends 2A of the laminar body 2 have an enlarged surface 2B, which allows the incorporation of a hole 2C that can be crossed by rivets 15 attaching to the electrical connection.

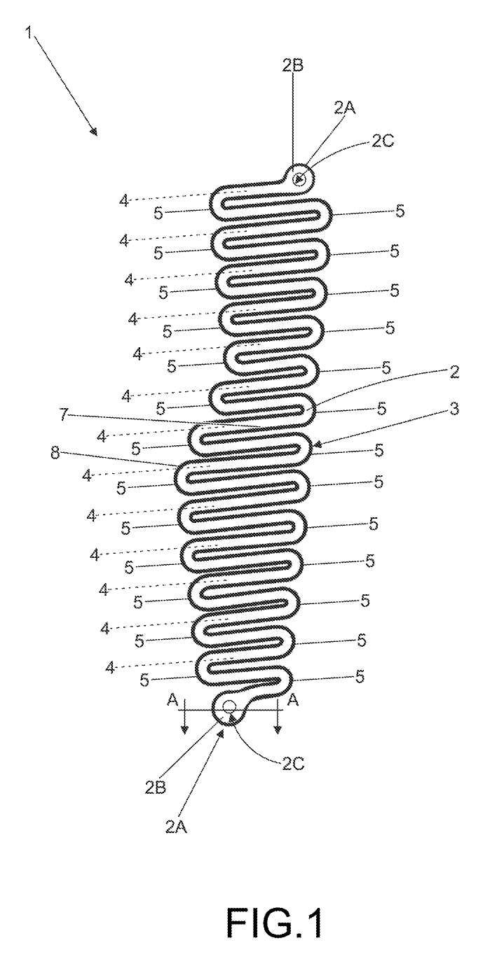

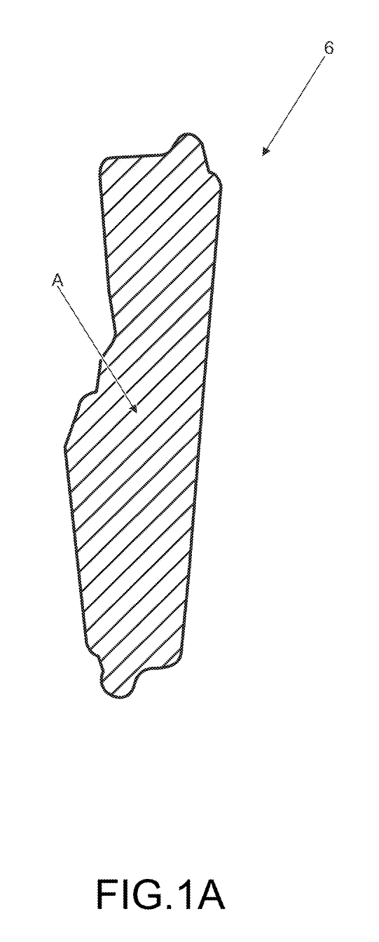

The laminar body 2 defines a heating and heat transfer area 6, schematically depicted in FIG. 1A and which is established by the cover produced by the parallel 4 and curved 5 portions of the strip 3.

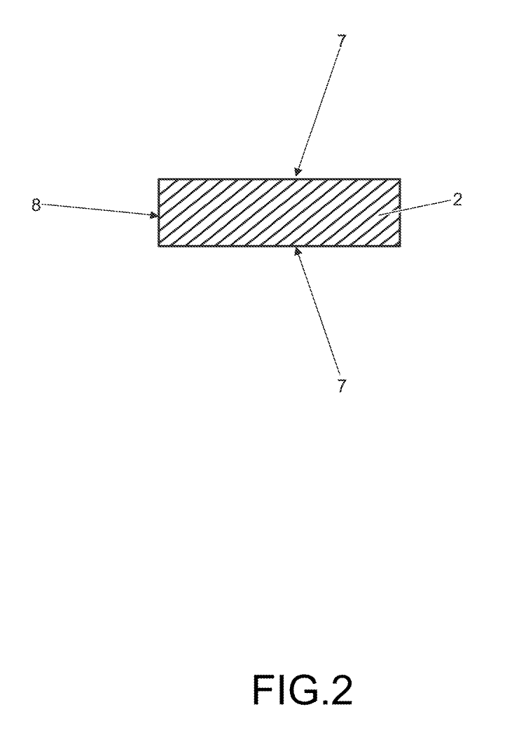

The stamped resistive element 1 shows two flat faces 7 and a perimeter contour face 8, which are particularly illustrated in FIGS. 1 and 2. The flat faces 7 and the perimeter contour face 8 are designed to have together an area A, which maximizes heat transfer in relation to the stream to be heated, which in the case of hair dryers and other similar equipment, is composed by air.

Therefore, the stamped resistive element 1 shows a substantially greater efficiency in relation to conventional resistances.

Practically, the stamped resistive element 1, when used in a hair dryer and when being fed with the standard voltage (110-220 volts), generates power around 40 to 700 watts, which can be considered extremely low compared to the power of other devices, which often need to generate between 1,500 and 2,000 watts or more to be acceptably efficient.

It happens that the low power produced by the stamped resistive element 1 is used more efficiently in the face of its larger thermal transfer area.

Therefore, the low power of about 40 to 700 watts, when transferred to the entire area of the stamped resistive element 1 (its two flat faces 7 and its perimeter contour face 8), allows the airflow to be properly heated at a compatible level and even higher to that verified with the conventional electric resistances that operate in the aforementioned values of 1,500 and 2,000 watts, preferably 1,200 watts.

By being able to operate at such low power without jeopardizing the efficiency, the apparatuses that use the stamped resistive element 1 show extremely low power consumption, a positive characteristic from which arises a number of advantages, such as: a) possibility to operate bi-volt effectively; b) possibility of using digital systems with regard to their on-off keys and selecting the temperature levels; c) possibility of being able to operate with rechargeable battery power and d) possibility to operate with USB connection.

The fact that the stamped resistive element 1 is obtained from a metal blank also facilitates that other formats could be developed, providing greater freedom in developing the general format of the hair dryers, which normally show the distinctive “bottle” contour.

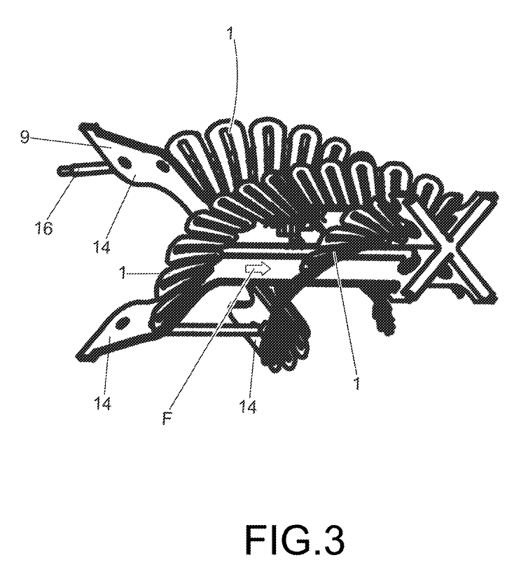

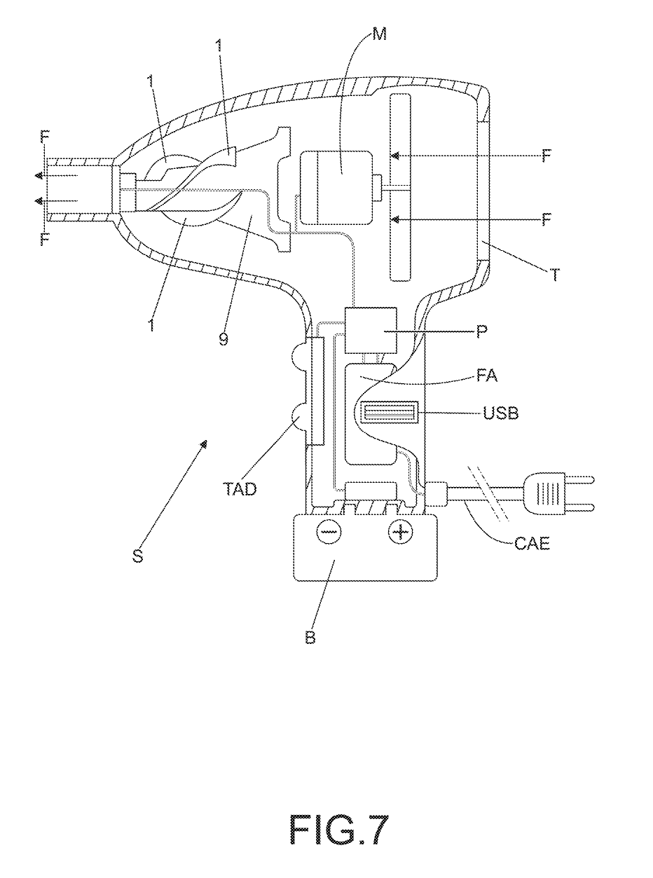

In the embodiment example of practical use illustrated in FIG. 3, a given number of stamped resistive elements 1 is mounted in a support structure 9, produced in insulating material (micanite) and which is dimensioned to be mounted on the body of a hair dryer of S manual type (depicted in FIG. 7).

It should be emphasized that the example of FIG. 3 does not limit this invention patent application, since the stamped resistive element 1 can be configured to be mounted in other models of equipment operating by heating principle.

Still regarding the example depicted in FIG. 3, an airflow F is indicated, which passes along the support structure 7, thus contacting the stamped resistive element 1.

In the case of a typical hair dryer, the airflow F is driven by a rotor or turbine T connected to an electric motor M, which sucks the external air into the body of the apparatus, forcing it to exit by its opposite end and forcing this airflow to pass through the heating element (conventional resistances). In the present case the same occurs, wherein the airflow F contacts the stamped resistive element 1.

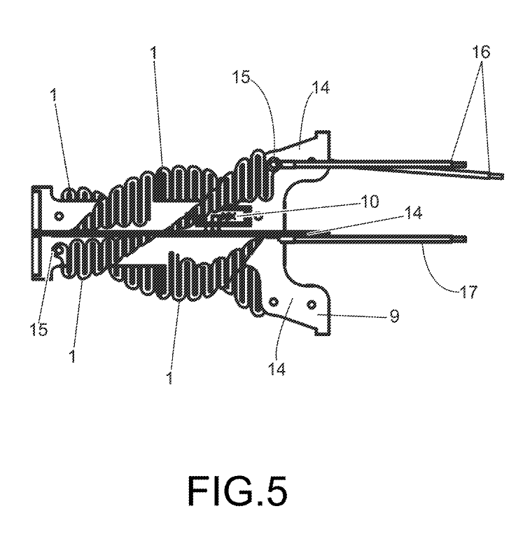

The support structure 9, such as depicted in FIG. 5, receives the mounting of a thermostat 10, which is electrically connected to the stamped resistive elements 1, thus regulating its working temperature range.

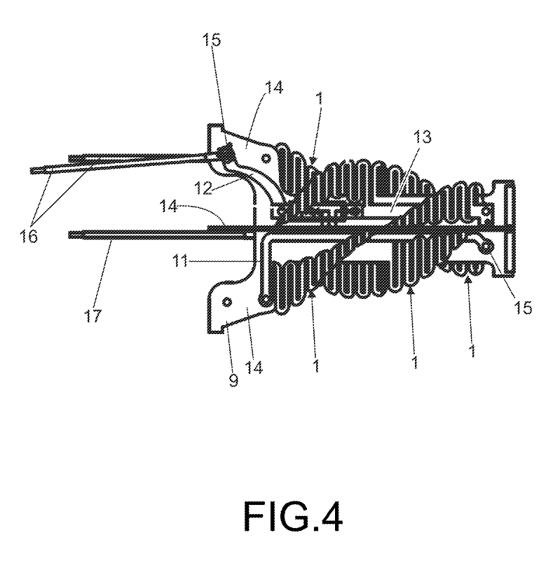

FIG. 4 depicts the fact that the stamped resistive elements 1 are electrically connected by terminals 11, 12 and 13, defined as laminar electrical conductors mounted in order to stay in close proximity with the faces 14 of the support structure 9.

Rivets 15 promote fixation of the terminals 11, 12 and 13 next to the already mentioned faces 14 of the support structure 9, wherein one of these rivets are used to promote fixation of the connecting cables 16, such connecting cables 16, together with a cable 17, being responsible for the electrical connection of the set of stamped resistive elements 1.

As seen in FIGS. 3, 4 and 5, the stamped resistive element 1 is mounted in a simple form in the support structure 9 and, differently from that seen with respect to conventional electrical resistances, it shows a contact area with the substantially higher airflow F.

The stamped resistive element 1, when incorporated to a hair dryer or other similar equipment, allows this equipment to be lighter, more economical and more efficient.

Differently from the hair dryers belonging to the state of the art and using helical electrical resistances, in the present case, the stamped resistive element 1 shows an essentially laminar structure, which simplifies greatly its mounting in the support structure 9.

FIG. 7 schematically illustrates a general diagram of a generic model of hair dryer S incorporating the stamped resistive elements 1.

In said FIG. 7, the stamped resistive elements 1, the support structure 9, the electrical motor M, the turbine or rotor T driven by the electrical motor M, a circuit board P operating the functions of the hair dryer S, a power supply FA, which is on one side connected to the external power cable CAE and, on the other side, to the mentioned circuit board P are schematically depicted.

In the same FIG. 7, it can be also noted that to the circuit board P is connected to a set of digital drive keys indicated by the reference TAD [teclas de acionamento digital].

Still regarding FIG. 7, the model of hair dryer S illustrated as a non-limitative example incorporates other two technical and functional characteristics enabled by low power with which it operates the stamped resistive element 1, one of them being the fact that said hair dryer S can be fed by battery B, or even by means of a USB connection.

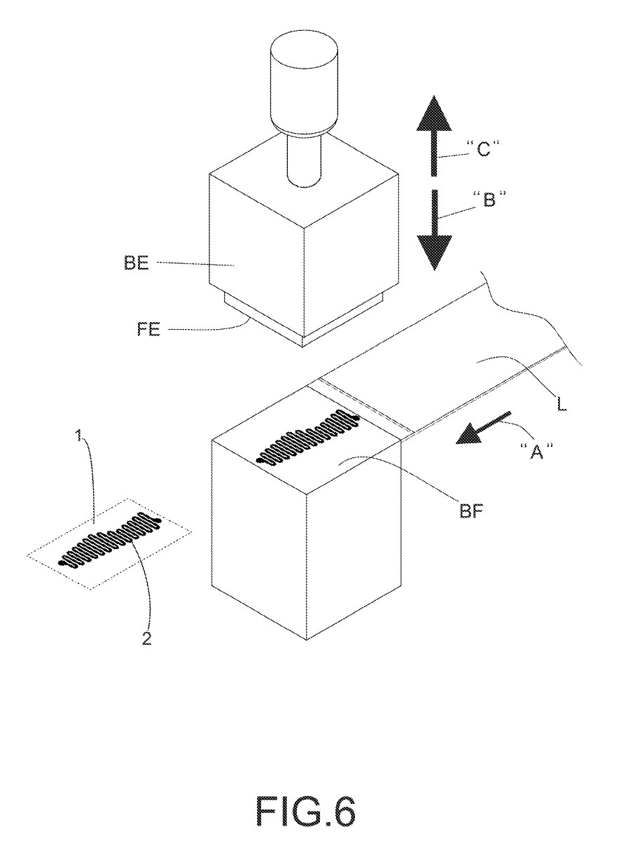

FIG. 6 illustrates a schematic view intended to depict the stamping process from which the stamped resistive element 1 is obtained.

In said FIG. 6, a laminar piece L, which can be presented in plates or in a continuous blade, in a first step, is subjected to a stamping tool FE, which, when activated, promotes the lowering of a stamping block BE against a fixed stamping block BF, which results, in a second step, the laminar body 2 configuring the stamped resistive element 1 herein proposed.

In the same FIG. 8, the arrows “A” are indicated, representing the advancement of the laminar piece L toward the stamping tool FE and the arrows “B” and “C”, representing the up and down movement of the stamping block BE.

Once again, it should be noted that the stamped resistive element 1, although intended for the branch of hair dryers, might have other applications replacing conventional helical resistances, reason why this patent application is not limited to the given example.

The stamped resistive element 1 herein proposed can be used including as a means of heating liquids and other substances.

Regardless of the use that may be made, the stamped resistive element 1 object of this invention patent application will represent a gain in efficiency, economy, weight reduction and also in the use of manpower necessary for its assembly.

More than this, in face of its simplicity of form, the stamped resistive element 1 can provide the introduction of automated assembly lines, also differing in this respect when compared to the helical electrical resistances belonging to the state of the art.

The stamped resistive element 1 herein proposed is produced from a metal sheet manufactured so as to have a previously known resistive coefficient.

As must have remained clear and evident, the stamped resistive element 1 herein proposed presents a series of advantages when compared to the conventional electrical resistances.

It should be emphasized that the stamped resistive element 1, as depicted in the figures illustrating this patent application, is not limited to the format in which it is displayed, since the configuration depicted herein has been specifically developed for use in hair dryers that does not limit the use of element 1 to other types of application, which may require other format configurations.

Still regarding the example of use, where the stamped resistive element 1 is applied to a hair dryer, it should be pointed out that the number of units of said element 1 may vary for more or less, the amount of four units not being an immutable condition.

In this sense, the support structure 9 can also be adjusted in relation to the number of units of the element 1 to be used, not being restricted to the illustrated configuration.

What is claimed is:

1. A stamped resistive element for use in electrical equipment, comprising a laminar body obtained as a metal blank.

2. The stamped resistive element according to claim 1, wherein the laminar body comprises a strip of flat surface defining parallel portions and the two ends, two flat faces, and a perimeter contour face, each of the parallel portions having continuity with a next one of the parallel portions through curved portions, the two ends have an enlarged surface that allows incorporation of a hole, the laminar body defines a heating and heat transfer area established by the parallel portions, the curved portions, the two flat faces, and the perimeter contour face.

3. The stamped resistive element according to claim 2, wherein the heat transfer area maximizes contact with a flow to be heated.

4. The stamped resistive element according to claim 1, further comprising a support structure made of insulating material, wherein the laminar body is mounted in the support structure.

5. A manufacturing process for making a stamped resistive element, comprising subjecting a laminar piece to a stamping tool so that a stamping block is lowered against a fixed block to configure the laminar piece into the stamped resistive element.

6. The manufacturing process of according to claim 5, wherein the laminar piece comprises a metal sheet with a known resistive coefficient.

7. A hair dryer comprising a stamped resistive element.

8. The hair dryer according to claim 7, further comprising digital drive keys.

9. The hair dryer according to claim 7, further comprising a battery.

10. The hair dryer according to claim 7, further comprising a USB connection.

11. The hair dryer according to claim 7, wherein the stamped resistive element comprises a laminar body having a strip of flat surface defining parallel portions and the two ends, two flat faces, and a perimeter contour face, each of the parallel portions having continuity with a next one of the parallel portions through curved portions, the two ends have an enlarged surface that allows incorporation of a hole, the laminar body defines a heating and heat transfer area established by the parallel portions, the curved portions, the two flat faces, and the perimeter contour face.

12. The hair dryer according to claim 11, wherein the heat transfer area maximizes contact with a flow to be heated.

13. The hair dryer according to claim 11, further comprising a support structure made of insulating material, wherein the laminar body is mounted in the support structure.
